(19) United States
(12) Patent Application Publication
(10) Pub. No.: US 2016/0052450 A1
(43) Pub. Date: Feb. 25, 2016

(54) HAPTIC FEEDBACK GUIDANCE FOR A VEHICLE APPROACHING A WIRELESS CHARGING LOCATION

(71) Applicant: GM GLOBAL TECHNOLOGY OPERATIONS LLC, Detroit, MI (US)

(72) Inventors: HSIU-PANG CHAN, OSHAWA (CA); ANDREW J. NAMOU, WEST BLOOMFIELD, MI (US)

(21) Appl. No.: 14/465,451

(22) Filed: Aug. 21, 2014

(51) Int. Cl. B60Q 9/00; H04L 29/08; B60L 11/18; H04W 4/02

(52) U.S. Cl. CPC B60Q 9/00; H04W 4/026; H04W 4/027; H04L 67/12; B60L 11/1809; B60L 11/182

(57) ABSTRACT

A method of guiding an operator of a vehicle to a target location of a wireless charging station is disclosed herein. An exemplary embodiment of the method determines proximity of the vehicle to the wireless charging station, and activates a haptic feedback subsystem onboard the vehicle to indicate an approach alignment of the vehicle relative to the target location. The haptic feedback subsystem can be operated to generate haptic output that indicates fore-aft and lateral alignment (or misalignment) of the vehicle relative to the target location.

### TECHNICAL FIELD

Embodiments of the subject matter described herein relate generally to wireless charging systems suitable for use with electric and hybrid electric vehicles. More particularly, embodiments of the subject matter relate to a methodology for guiding a driver of a vehicle to a target location of a wireless charging station.

### BACKGROUND

Electric and hybrid electric vehicles are becoming increasingly popular. Traditional plug-in electric vehicles include an energy storage system (typically a battery pack) that can be recharged by physically connecting a charging cable to a charging port on the vehicle. Wireless electrical charging systems have also been developed for use with hybrid electric and fully electric vehicles. Such wireless charging systems utilize magnetic induction techniques to establish an electromagnetic coupling between: (1) a charging pad or platform external to the vehicle; and (2) a compatible receiver component onboard the vehicle. The receiver component is electrically coupled to the rechargeable battery pack to provide charging current (induced by the external charging component) to the battery pack.

The charging pad is usually located on the ground such that wireless charging can be performed after the vehicle is parked over the charging pad. Optimal wireless charging is achieved when the receiver component of the vehicle is properly aligned and positioned relative to the external charging pad. Thus, the driver should strive to precisely park the vehicle in a specified target location.

Accordingly, it is desirable to have a reliable and accurate system that provides guidance to a driver while approaching a wireless charging station. Furthermore, other desirable features and characteristics will become apparent from the subsequent detailed description and the appended claims, taken in conjunction with the accompanying drawings and the foregoing technical field and background.

### BRIEF SUMMARY

A method of guiding an operator of a vehicle to a target location of a wireless charging station is disclosed. An exemplary embodiment of the method determines proximity of the vehicle to the wireless charging station, and activates a haptic feedback subsystem onboard the vehicle to indicate an approach alignment of the vehicle relative to the target location.

Also disclosed herein is an onboard operator guidance system for a vehicle. An exemplary embodiment of the system includes an inductive charging component onboard the vehicle, a haptic feedback subsystem onboard the vehicle, and a control module. The inductive charging component supports wireless charging of the vehicle. The control module has at least one processor device that obtains a measurement that indicates a current approach position of the vehicle relative to a target location of a wireless charging station. The control module operates the haptic feedback subsystem in accordance with the obtained measurement to haptically indicate alignment or misalignment of the vehicle relative to the target location.

Also disclosed herein is a computer readable storage media having processor-executable instructions capable of performing a method that determines a current approach position of a vehicle relative to a target location of a wireless charging station. The method continues by operating a haptic feedback subsystem of the vehicle, in accordance with the determined current approach position, to haptically indicate alignment or misalignment of the vehicle relative to the target location.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a simplified diagram of a wireless vehicle charging system;

FIG. 2 is a diagram that shows a vehicle approaching a wireless charging station;

FIG. 3 is a top view of a vehicle seat having haptic feedback elements integrated therein;

FIG. 4 is a flow chart that illustrates an exemplary embodiment of a method of guiding an operator of a vehicle to a target location of a wireless charging station;

FIG. 5 is a diagram of a vehicle approaching a target location of a wireless charging station on a path that is laterally aligned with the target location;

FIG. 6 is a diagram of a vehicle approaching a target location of a wireless charging station on a path that is laterally misaligned (to the left side) with the target location;

FIG. 7 is a diagram of a vehicle approaching a target location of a wireless charging station on a path that is laterally misaligned (to the right side) with the target location; and

FIG. 8 is a schematic representation of an onboard operator guidance system for a vehicle, according to exemplary embodiments of the invention.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. Moreover, it should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in any processor-readable medium, which may be realized in a tangible form. The “processor-readable medium” or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, or the like.

The subject matter presented here relates to wireless charging of a vehicle using, for example, magnetic induction technology. More specifically, the subject matter presented here relates to a methodology that provides guidance to the driver of a vehicle while approaching a wireless charging station having a charging pad at a target location. In certain implementations, wireless charging may require very close alignment tolerances between the parked vehicle and the charging pad. For example, it may be necessary to park the vehicle within 500 mm of the charging pad to achieve optimized wireless charging efficiency. As described in more detail below, a haptic feedback system onboard the vehicle is activated to provide tactile information to the driver while the vehicle is approaching the target location of the wireless charging station. Different forms of haptic feedback (e.g., different vibration patterns) are generated to indicate whether or not the vehicle is laterally aligned with the target location and/or whether or not the vehicle is longitudinally aligned with the target location.

FIG. 1 is a simplified diagram of a wireless charging station 100 for a vehicle 102 having a rechargeable energy source 104 such as a battery pack suitable for use with an electric traction motor (not shown). The vehicle 102 includes an inductive charging component 106, which is integrated with or is otherwise onboard the vehicle 102. The inductive charging component 106 is compatible with a wireless charging pad 108 of the wireless charging station 100. For this example, the wireless charging pad 108 is located on the ground or floor of the wireless charging station 100, and it is positioned in accordance with a target location that serves as the desired, ideal, or optimized parking location for the vehicle 102 (for purposes of efficient and effective wireless charging). FIG. 1 depicts the vehicle 102 parked in the target location, such that the inductive charging component 106 is aligned in both dimensions with the wireless charging pad 108. In this regard, the vehicle 102 in FIG. 1 is considered to be in proper fore-aft alignment and in proper starboard-port alignment with the target location.

In accordance with well-known magnetic induction charging technology, the wireless charging pad 108 can be activated to generate a magnetic field proximate the inductive charging component 106. The generated magnetic field induces an electric current in the inductive charging component 106. The induced current is used to charge the energy source 104 of the vehicle. As mentioned previously, the best wireless charging performance is obtained when the inductive charging component 106 is properly aligned with the wireless charging pad 108. Accordingly, the driver should strive to park the vehicle 102 precisely in the target location.

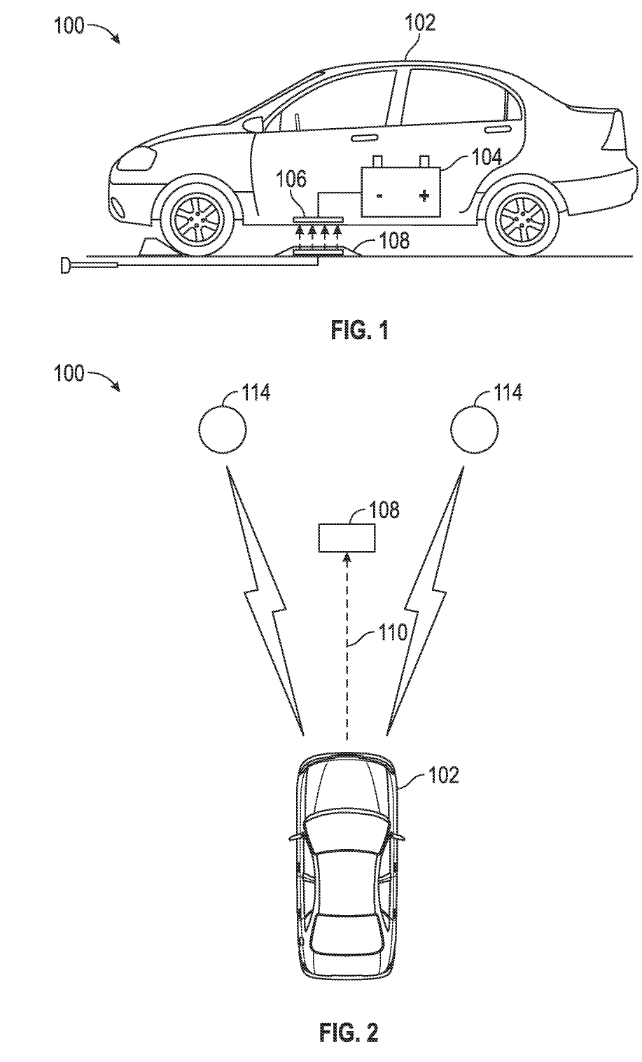

FIG. 2 is a diagram that shows the vehicle 102 approaching the wireless charging station 100. It should be appreciated that the wireless charging station 100 may be located in a garage, a parking lot, a gas station, a repair facility, a vehicle charging facility, or the like. The top view of FIG. 2 corresponds to a moment in time when the vehicle 102 has not yet reached the target location. In other words, the vehicle 102 is still approaching the wireless charging pad 108. In FIG. 2, the dashed arrow represents the ideal and desired approach path 110 for the vehicle 102. Notably, the approach path 110 is laterally aligned with the target location. Thus, if the vehicle follows the approach path 110, then it will be properly oriented from the starboard/port perspective.

Although not always required, FIG. 2 depicts a sensor system having two sensors 114. In practice, the sensor system may include only one sensor 114, or it may include more than two sensors 114. The sensor system is described in more detail below. The sensor system may be considered to be a part of the wireless charging station 100, or it may be considered to be a stand-alone system that cooperates with the wireless charging station 100 and the vehicle 102.

The vehicle 102 includes an onboard haptic feedback subsystem that can be activated in a manner that indicates the approach alignment (or misalignment) of the vehicle 102 relative to the target location and/or relative to the wireless charging pad 108. In accordance with various embodiments, the haptic feedback subsystem includes at least one haptic element integrated into a driver seat of the vehicle 102. In various embodiments, the haptic feedback subsystem may additionally or alternatively include at least one haptic element integrated into a steering wheel of the vehicle 102, integrated into a control pedal of the vehicle 102, integrated into a knob or other user interface component of the vehicle 102, or the like.

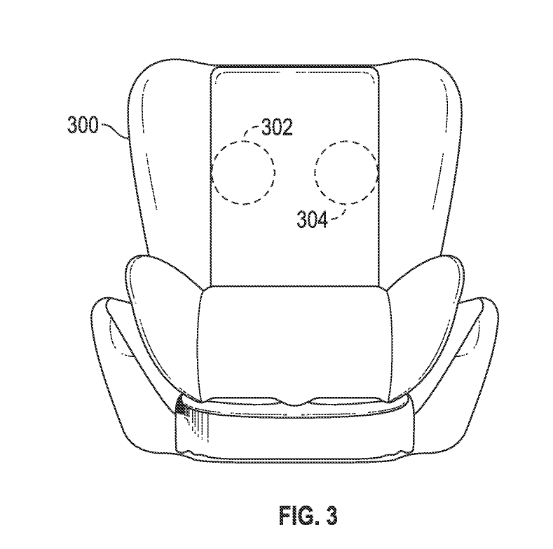

FIG. 3 is a top view of a vehicle seat 300 having two haptic elements 302, 304 integrated therein. The exemplary embodiment described here uses the haptic elements 302, 304 as directional indicators, as explained in more detail below. In other embodiments, more than two independently controlled haptic elements could be utilized. Moreover, a single haptic element with multiple modes or distinguishable haptic characteristics could be utilized instead of two separate haptic elements. For the illustrated embodiment, the haptic element 302 is biased toward the left or port side of the seat 300, and the haptic element 304 is biased toward the right or starboard side of the seat 300. The illustrated embodiment of the seat 300 includes the haptic elements 302, 304 in the bottom seat cushion. Alternatively or additionally, an embodiment of the seat 300 may include haptic elements in the seat back, in the seat bolsters, in the seat headrest, and/or in the seat arm rests, as desired for the particular implementation.

The haptic feedback subsystem activates one or both of the haptic elements 302, 304 to produce a response that can be felt/detected by the person occupying the seat 300 (e.g., the driver of the vehicle 102). The embodiment described here employs vibrating transducers for the haptic elements 302, 304, wherein each haptic element 302, 304 is controlled to produce vibrating pulses that can be felt through the cushion of the seat 300. The pulse frequency, pulse magnitude, pulse duty cycle, and/or other haptic characteristics are controlled in accordance with the various methods and techniques described in more detail here. In certain embodiments, the haptic characteristics are controlled to indicate fore-aft alignment of the vehicle 102 (i.e., the longitudinal distance from the target location) and starboard-port alignment of the vehicle 102 (i.e., the lateral left-right alignment) to the operator. In other embodiments, different types of haptic elements could be used as long as they can be controlled and modulated to indicate alignment of the vehicle in the manner described here. For example, the haptic feedback subsystem may utilize any of the following, without limitation: a motor activated vibrator; a piezoelectric transducer; an electromagnetic micro coil; a pneumatic valve; or any combination thereof

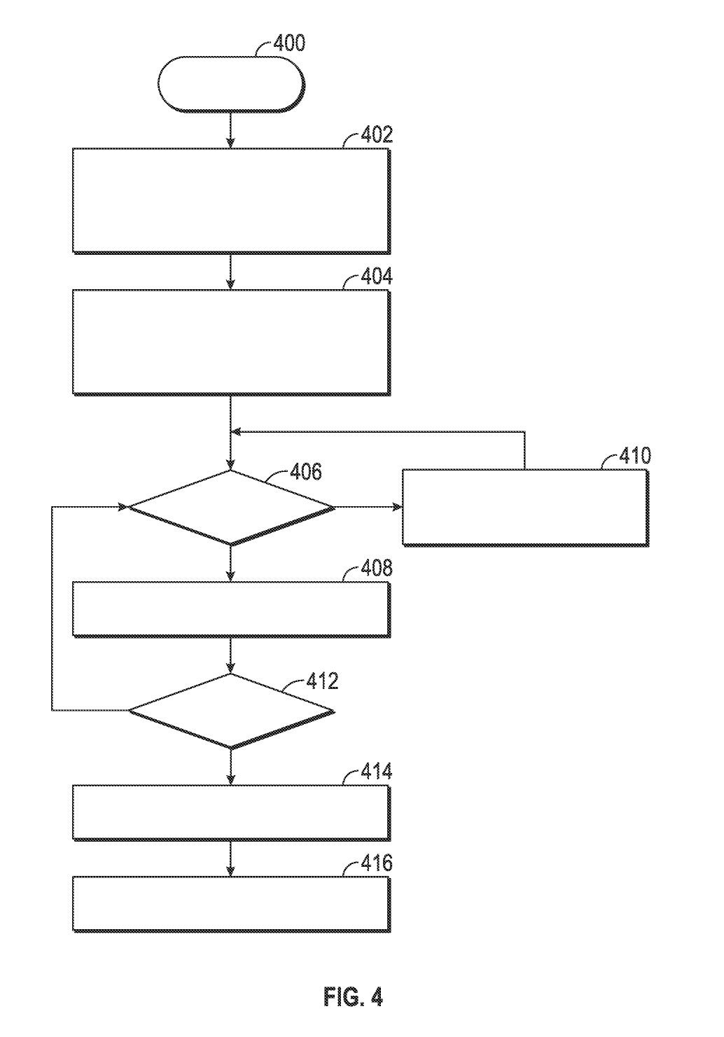

FIG. 4 is a flow chart that illustrates an exemplary embodiment of a process 400 for guiding an operator of a vehicle to a target location of a wireless charging station. The various tasks performed in connection with the process 400 may be performed by software, hardware, firmware, or any combination thereof For illustrative purposes, the following description of the process 400 may refer to elements mentioned above in connection with FIGS. 1-3. In practice, portions of the process 400 may be performed by different elements of the described system, e.g., the charging station, the vehicle, or a component onboard the vehicle. It should be appreciated that the process 400 may include any number of additional or alternative tasks, the tasks shown in FIG. 4 need not be performed in the illustrated order, and the process 400 may be incorporated into a more comprehensive procedure or process having additional functionality not described in detail herein. Moreover, one or more of the tasks shown in FIG. 4 could be omitted from an embodiment of the process 400 as long as the intended overall functionality remains intact.

This example assumes that the process 400 has been initiated by an appropriate mechanism, subsystem, or logic onboard the host vehicle. For example, the process 400 could be initialized as soon as the vehicle detects the presence of the charging station and/or the wireless charging pad. Proximity to the charging pad may be detected by monitoring the strength of the magnetic field or magnetic coupling between the charging pad and the onboard inductive charging component. As another example, the process 400 could be initialized by an onboard navigation or geographic positioning system. In this regard, the geographic location of the charging station could be stored for purposes of initiating the process 400 whenever the vehicle is within a specified distance from the charging station. As yet another example, the process 400 could be launched in response to a command or an instruction entered by the driver. In accordance with some embodiments, the process 400 is initiated using a detection or triggering mechanism or system. For example, an onboard wireless communication system could be used to determine when the vehicle is within close proximity to the charging station. In such embodiments, the charging station (or a component located at or near the charging station) may broadcast a ping or beacon signal that serves as a notification to the vehicle. Alternatively or additionally, the charging station may employ an infrared sensor, a motion sensor, a pressure pad embedded in the ground, or the like.

The process 400 is performed while the vehicle is approaching the wireless charging station. The process 400 may begin by determining proximity of the vehicle to the wireless charging station and/or by determining the approach position of the vehicle relative to the target location of the charging station (task 402). The current position and alignment of the vehicle (and/or the onboard inductive charging component) relative to the target location may be obtained in a variety of different ways. In certain embodiments, task 402 obtains a measurement that indicates the current approach position of the vehicle relative to the target location, such that the haptic feedback subsystem can be activated in accordance with the obtained measurement. The position measurement may be based on magnetic coupling characteristics (e.g., magnitude, directionality, etc.) detected by the onboard inductive charging component as it interacts with the charging pad. As another example, the current position of the vehicle may be obtained from position data that is received at the vehicle. The position data could be received from a sensor system (see FIG. 2) that is associated with the charging station. In practice, the sensor system could be implemented using RFID technology, GPS technology, wireless networking technology (such as triangulation), optical or imaging technology, or the like.

Using one or more of the techniques mentioned above, the process 400 obtains and analyzes the current position of the vehicle as it approaches the target location, and activates the haptic feedback subsystem onboard the vehicle to guide the driver to the target location and to indicate the approach alignment of the vehicle relative to the target location. The haptic feedback subsystem is operated and controlled in accordance with the obtained position measurement to haptically indicate the alignment/orientation of the vehicle relative to the target location and, therefore, relative to the wireless charging pad. This example assumes that the vehicle begins its approach along a path that is laterally aligned with the target location. Accordingly, the haptic feedback subsystem is activated and operated to generate an initial haptic output that indicates proper lateral alignment of the vehicle, even though the vehicle has not yet reached the target (task 404). More specifically, task 404 activates both haptic elements to generate low frequency pulses on both sides of the driver seat. Activation of both haptic elements indicates starboard-port (lateral) alignment of the vehicle relative to the target location. Moreover, the low frequency of the pulses indicates that the vehicle is too far away from the target location.

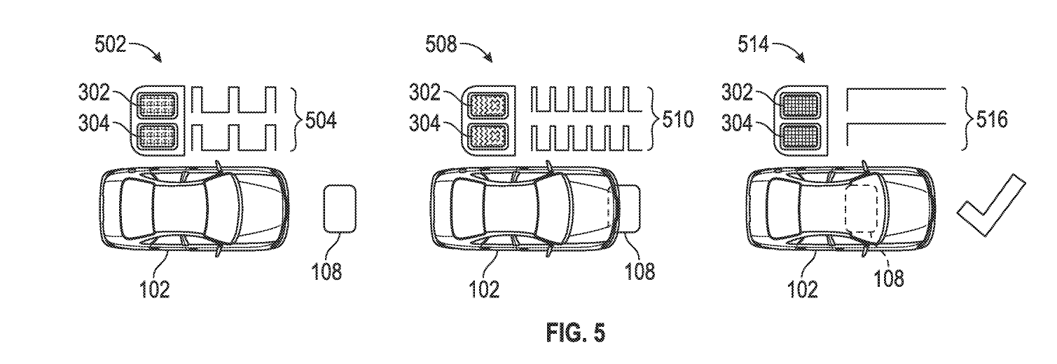

FIG. 5 is a diagram of the vehicle 102 approaching the target location of the wireless charging station on a path that is laterally aligned with the target location. When the vehicle 102 is at the first position 502, both haptic elements 302, 304 are activated at a low pulse frequency. The plots 504 represent the resulting pulse pattern of the haptic elements 302, 304. FIG. 5 depicts the vehicle 102 continuing along a straight path toward the wireless charging pad 108. For the illustrated scenario, the haptic elements 302, 304 are activated to generate haptic output with a pulse frequency that varies in accordance with the fore-aft alignment of the vehicle relative to the target location. Thus, when the vehicle 102 is at the second position 508, both haptic elements 302, 304 are activated at a higher pulse frequency. The plots 510 represent the resulting pulse pattern of the haptic elements 302, 304. Eventually, the vehicle 102 is correctly aligned with the wireless charging pad 108, in both fore-aft and starboard-port directions. The third position 514 shown in FIG. 5 represents the desired parking position for the vehicle 102. When the vehicle 102 is aligned in the fore-aft direction, the haptic elements 302, 304 are activated to generate haptic output at a much higher frequency (or continuously as depicted in FIG. 5). The plots 516 represent the resulting output of the haptic elements 302, 304.

Referring back to FIG. 4, the process 400 checks whether the vehicle remains laterally aligned with the target location (query task 406). The vehicle may be considered to be laterally aligned if its current position is within a threshold distance from the ideal or intended approach path. For example, lateral alignment may be satisfied if the vehicle is offset from the desired approach path by no more than about 10-20 centimeters. If the vehicle 102 is laterally aligned, then the process 400 adjusts the pulse frequency of the haptic elements as a function of fore-aft alignment (task 408), i.e., the pulse frequency varies as a function of the distance to the target location. As mentioned above, the pulse frequency increases as the vehicle gets closer to the target location, and the pulse frequency decreases as the vehicle moves away from the target location. The change in pulse frequency is detectable by the driver during the approach to the target location, and a very high frequency (or continuous) haptic output may signify that the target location has been reached. If the vehicle is not laterally aligned with the target location (the “No” branch of query task 406), then the process 400 operates the haptic feedback subsystem to generate a haptic output that indicates starboard-port misalignment of the vehicle relative to the target location (task 410).

For the example described here, task 410 generates haptic output with a first directional characteristic when the vehicle is starboard misaligned relative to the target location (i.e., the vehicle is offset to the right), and generates haptic output with a second directional characteristic when the vehicle is port misaligned relative to the target location (i.e., the vehicle is offset to the left). In this regard, the driver can detect whether the vehicle is misaligned to the left or to the right and compensate by steering the vehicle toward the desired approach path.

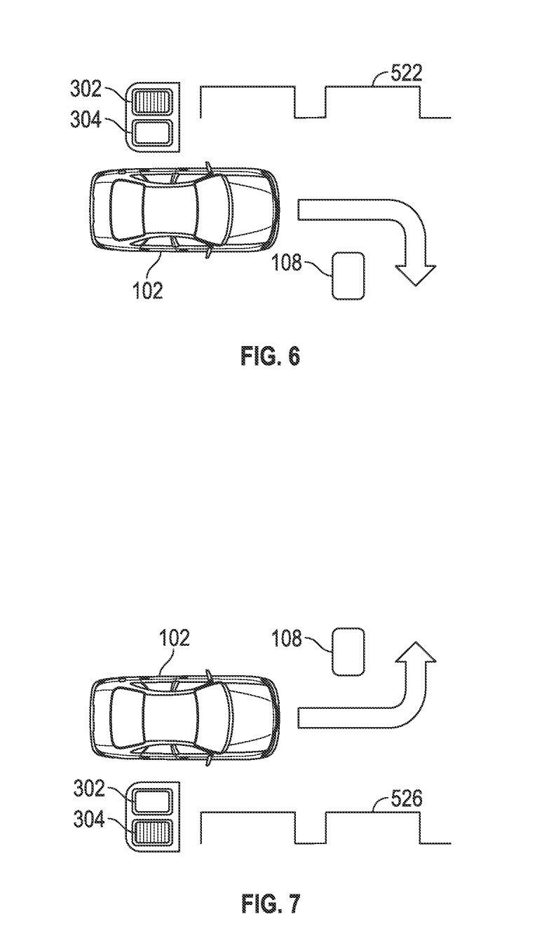

FIG. 6 is a diagram of the vehicle 102 approaching the wireless charging pad 108 on a path that is laterally misaligned (to the port side) with the target location, and FIG. 7 is a diagram of the vehicle 102 approaching the wireless charging pad 108 on a path that is laterally misaligned (to the starboard side) with the target location. For this particular embodiment, when the vehicle 102 is approaching to the left side of the target location (see FIG. 6), the left side haptic element 302 is activated and the right side haptic element 304 is deactivated. In alternative embodiments, the left side haptic element 302 is deactivated and the right side haptic element 304 is activated. Moreover, the left side haptic element 302 may be operated to generate a haptic output that is distinguishable from the other haptic pulse patterns that could be generated during approach. For example, the plot 522 in FIG. 6 represents an exemplary pulse pattern of the left side haptic element 302. For this example, a pattern of two long pulses on the left side of the driver seat indicates that the vehicle is offset to the left. Conversely, when the vehicle 102 is approaching to the right side of the target location (see FIG. 7), the right side haptic element 304 is activated and the left side haptic element 302 is deactivated (or vice versa). Moreover, the right side haptic element 304 may be operated to generate a haptic output that is distinguishable from the other haptic pulse patterns that could be generated during approach. In this regard, the plot 526 in FIG. 7 represents an exemplary pulse pattern of the right side haptic element 304. For this example, a pattern of two long pulses on the right side of the driver seat indicates that the vehicle is offset to the right.

Referring back to FIG. 4, the process 400 also checks whether the vehicle is centered relative to the target location and/or relative to the wireless charging pad 108 (query task 412). The vehicle may be considered to be longitudinally aligned if its current position is within a threshold distance from the ideal or intended target position. For example, fore-aft alignment may be satisfied if the vehicle is offset from the desired target by no more than about 5-15 centimeters. If the vehicle is not yet centered (the “No” branch of query task 412), the process 400 may return to query task 406 to continue checking the lateral and longitudinal position and alignment in the manner described above. Thus, the process 400 may continue in an ongoing manner during the approach, and operate the haptic feedback subsystem in different modes to generate distinguishable haptic output that indicates fore-aft (longitudinal) and starboard-port (lateral) alignment of the vehicle relative to the desired target. If the position measurement of the vehicle indicates that the current position of the vehicle 102 is properly aligned with the target location and the wireless charging pad 108 (the “Yes” branch of query task 412), the process 400 operates the haptic feedback subsystem to generate a haptic output that conveys a confirmation to the driver (task 414). The haptic output generated at this time may be a unique pulse pattern, a specific number of pulses (e.g., four long pulses), or the like.

The haptic feedback generated during the approach to the charging station is predictive in that the goal is to help the driver maneuver the vehicle into the desired destination position during the approach. Ideally, the haptic guidance provides early indication that allows the driver to steer and adjust the position of the vehicle while slowly moving toward the wireless charging pad 108, and such that substantially continuous and real-time adjustments can be made before the vehicle actually reaches the wireless charging pad 108. After reaching the target location, the vehicle 102 should be in a good position for effective and efficient wireless charging. The process 400 may proceed with the wireless charging procedure after the vehicle 102 is parked and shut down (task 416).

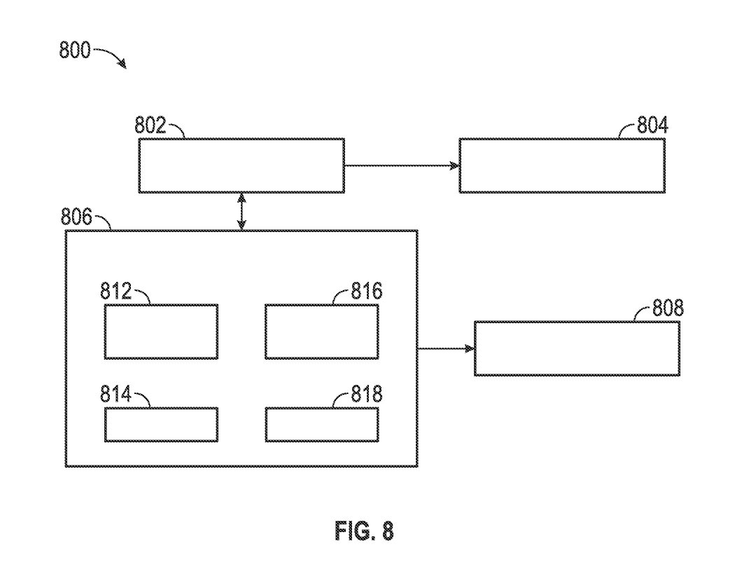

FIG. 8 is a schematic representation of an onboard operator guidance system 800 for the vehicle 102, according to exemplary embodiments of the invention. The system 800 may include, without limitation: an inductive charging component 802 onboard the vehicle; a rechargeable energy storage element 804 (such as a battery or battery pack); at least one control module 806; and a haptic feedback subsystem 808. The inductive charging component 802 is coupled to the energy storage element 804 to accommodate charging as needed in the manner described above. The inductive charging component 802 may be operatively coupled to the control module 806 to facilitate the communication of position measurement information (e.g., magnetic coupling, magnetic field strength, etc.). The control module 806 is coupled to the haptic feedback subsystem 808 to regulate the operation of the haptic elements.

The process 400 and other functions related to the haptic guidance feature described here may be performed by the control module 806 onboard the host vehicle 102. Although one control module 806 can manage the described functionality, various embodiments may employ a plurality of control modules or electronic control units (ECUs) to support the functionality in a cooperative and distributed manner. For simplicity, only one control module 806 is shown and described here.

The illustrated embodiment of the control module 806 generally includes, without limitation: at least one processor device 812; general purpose memory 814; computer-readable storage media 816; and a communication module 818. In practice, the control module 806 may include additional elements, devices, and functional modules that cooperate to achieve the desired functionality.

The processor device 812 is capable of executing the processor-executable instructions stored in the computer-readable storage media 816, wherein the instructions cause the control module 806 to perform the various processes, operations, and functions described above. In practice, the processor device 812 may be implemented as a microprocessor, a number of discrete processor devices, content addressable memory, an application specific integrated circuit, a field programmable gate array, any suitable programmable logic device, discrete gate or transistor logic, discrete hardware components, or any combination designed to perform the functions described here.

The memory 814 may be utilized to store program code that defines an operating system, a boot loader, or a BIOS for the control module. Moreover, the memory 814 may include random access memory that serves as temporary data storage for the processor device 812. In this regard, the processor device 812 can write to and read from the memory 814 as needed to support the operation of the control module 806.

The communication module 818 may be realized using software, firmware, hardware, processing logic, or any suitable combination thereof In certain exemplary embodiments, the communication module 818 is suitably configured to support data communication between the control module 806 and other modules, ECUs, or devices onboard the host vehicle. The communication module 818 may also be designed to support data communication with external devices or sources. For example, the communication module 818 may be used to receive sensor data or position data that indicates the current location of the vehicle 102 relative to the desired target location. As another example, the communication module 818 may be used to receive a command or instruction to initialize the haptic guidance function.

It should be appreciated that the haptic feedback elements can be controlled in any desired manner, depending on the embodiment, the vehicle make and/or model, user preferences, and the like. The specific haptic feedback pulse patterns and characteristics described above are not intended to be limiting or restrictive in any way. In this regard, the haptic feedback subsystem can be operated in any desired manner to generate distinguishable haptic outputs that indicate whether the vehicle is laterally aligned with the desired approach path, whether the vehicle is longitudinally aligned with the target location of the charging station, and whether the vehicle is centered on the target location (i.e., whether the vehicle has reached the desired charging spot).

Although FIGS. 5-7 depict individual haptic feedback modes, an embodiment of the system need not generate distinct and independent haptic output in this manner The methodology described here is merely one simple implementation. In this regard, two or more forms of haptic output could be “superimposed” to produce haptic feedback that indicates misalignment in more than one direction. For example, a relatively low frequency pulse could be generated along with two discernable “thumps” on one side of the seat to indicate that the vehicle is relatively far away and laterally offset from the intended target location. Moreover, the process 400 may be performed in a continuously updated manner such that the driver experiences variable haptic feedback in an ongoing manner during the approach, wherein the pulse frequency, magnitude, duty cycle, and other characteristics are modulated as needed, and wherein the different haptic feedback elements are individually controlled as needed.

The foregoing description and figures relate to a static charging station that wirelessly charges a stationary (parked) vehicle. The techniques and methodologies presented here could also be utilized in conjunction with dynamic wireless charging, wherein a vehicle in motion is charged while passing over wireless charging elements located in or on the road surface. In this regard, the charging elements may be positioned along an intended travel path such that optimized charging is achieved when the vehicle is laterally aligned with the intended path. Accordingly, the haptic guidance feature described above could be implemented to indicate whether or not the vehicle is traveling along the desired path.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method of guiding an operator of a vehicle to a target location of a wireless charging station, the method comprising:
determining proximity of the vehicle to the wireless charging station; and
activating a haptic feedback subsystem onboard the vehicle to indicate an approach alignment of the vehicle relative to the target location.

2. The method of claim 1, wherein activating the haptic feedback subsystem comprises:
operating the haptic feedback subsystem to generate a haptic output that indicates fore-aft alignment or misalignment of the vehicle relative to the target location.

3. The method of claim 2, wherein operating the haptic feedback subsystem comprises:
generating the haptic output with a pulse frequency that varies in accordance with the fore-aft alignment or misalignment of the vehicle relative to the target location.

4. The method of claim 1, wherein activating the haptic feedback subsystem comprises:
operating the haptic feedback subsystem to generate a haptic output that indicates starboard-port alignment or misalignment of the vehicle relative to the target location.

5. The method of claim 4, wherein operating the haptic feedback subsystem comprises:
generating the haptic output with a first directional characteristic when the vehicle is starboard-misaligned relative to the target location; and
generating the haptic output with a second directional characteristic when the vehicle is port-misaligned relative to the target location.

6. The method of claim 1, further comprising:
obtaining a measurement that indicates a current position of the vehicle relative to the target location, wherein the haptic feedback subsystem is activated in accordance with the obtained measurement.

7. The method of claim 6, wherein obtaining the measurement comprises:
detecting magnetic coupling characteristics with an inductive charging component onboard the vehicle, wherein the measurement is based on the detected magnetic coupling characteristics.

8. The method of claim 6, wherein obtaining the measurement comprises:
receiving, at the vehicle, position data from a sensor system associated with the charging station, wherein the measurement is based on the received position data.

9. The method of claim 6, further comprising:
detecting when the measurement indicates that the current position of the vehicle is centered relative to the target location; and
in response to the detecting, operating the haptic feedback subsystem to generate a haptic output that conveys a confirmation.

10. An onboard operator guidance system for a vehicle, the system comprising:
an inductive charging component onboard the vehicle, the inductive charging component configured to support wireless charging of the vehicle;
a haptic feedback subsystem onboard the vehicle; and
a control module comprising at least one processor device configured to obtain a measurement that indicates a current approach position of the vehicle relative to a target location of a wireless charging station, and to operate the haptic feedback subsystem in accordance with the obtained measurement to haptically indicate alignment or misalignment of the vehicle relative to the target location.

11. The system of claim 10, wherein the control module operates the haptic feedback subsystem to generate a haptic output that indicates fore-aft alignment or misalignment of the vehicle relative to the target location.

12. The system of claim 11, wherein the control module operates the haptic feedback subsystem with a pulse frequency that varies in accordance with the fore-aft alignment or misalignment of the vehicle relative to the target location.

13. The system of claim 10, wherein the control module operates the haptic feedback subsystem to generate a haptic output that indicates starboard-port alignment or misalignment of the vehicle relative to the target location.

14. The system of claim 13, wherein the control module operates the haptic feedback subsystem to generate the haptic output with a first directional characteristic when the vehicle is starboard-misaligned relative to the target location, and to generate the haptic output with a second directional characteristic when the vehicle is port-misaligned relative to the target location.

15. The system of claim 10, wherein the control module obtains the measurement based on magnetic coupling characteristics detected by the inductive charging component, the magnetic coupling characteristics associated with electromagnetic interaction between a charging element of the wireless charging station and the inductive charging component.

16. The system of claim 10, wherein the haptic feedback subsystem comprises at least one haptic element integrated into a driver seat of the vehicle.

17. The system of claim 10, wherein the haptic feedback subsystem comprises at least one haptic element integrated into a steering wheel of the vehicle.

18. A computer readable storage media comprising processor-executable instructions capable of performing a method comprising:
determining a current approach position of a vehicle relative to a target location of a wireless charging station; and
operating a haptic feedback subsystem of the vehicle, in accordance with the determined current approach position, to haptically indicate alignment or misalignment of the vehicle relative to the target location.

19. The computer readable storage media of claim 18, wherein the method performed by the processor-executable instructions comprises:
operating the haptic feedback subsystem in a first mode to generate a haptic output that indicates fore-aft alignment or misalignment of the vehicle relative to the target location; and
operating the haptic feedback subsystem in a second mode to generate a haptic output that indicates starboard-port alignment or misalignment of the vehicle relative to the target location.

20. The computer readable storage media of claim 18, wherein the method performed by the processor-executable instructions determines the current approach position based on magnetic coupling interaction between an inductive charging component onboard the vehicle and a charging element of the wireless charging station.
